(19) United States
(12) Patent Application Publication
(10) Pub. No.: US 2013/0161888 A1
(43) Pub. Date: Jun. 27, 2013

(54) JOUNCE BUMPER

(71) Applicant: E I DU PONT DE NEMOURS AND COMPANY, Wilmington, DE (US)

(72) Inventors: PETER LASZLO SZEKELY, PRINGY (FR); DAMIEN VAN DER ZYPPE, CHAMPIGNY SUR MARNE (FR); SEBASTIEN THOMASSON, MEYRIN (CH); THIERRY DONIS, PARIS (FR)

(73) Assignee: E I DU PONT DE NEMOURS AND COMPANY, Wilmington, DE (US)

(21) Appl. No.: 13/716,276

(22) Filed: Dec. 17, 2012

Related U.S. Application Data
(60) Provisional application No. 61/578,317, filed on Dec. 21, 2011.

(51) Int. Cl. B60G 11/22; B60G 15/06

(52) U.S. Cl. CPC B60G 11/22; B60G 15/06
USPC 267/220; 267/292

(57) ABSTRACT

Jounce bumper (14) for mounting in a vehicle suspension system comprising a shock absorber with a cylinder and a slidable piston rod (12), the jounce bumper (14) including an elastically compressible bumper portion (24) comprising an axially extending central bore (15) for receiving the piston rod therethrough, a mounting portion (18) positioned at one end of the bumper portion configured for mounting the jounce bumper to a component of the vehicle suspension system, and a bending lip positioned at an opposite end of the bumper portion and configured to generally surround the piston rod, the bending lip comprising a contact edge configured to contact a striker plate of the shock absorber during compression of the shock absorber. The contact edge is configured to contact said striker plate on only part of a closed circumference surrounding the piston rod, at least during initial contact between the bending lip and striker plate.

### CROSS REFERENCE TO RELATED APPLICATIONS

This application claims priority under 35 USC 119(e) from U.S. Provisional Application No. 61/578,317, filed Dec. 21, 2011, and currently pending.

### FIELD OF THE INVENTION

This invention relates to a jounce bumper for a vehicle suspension system.

### BACKGROUND OF THE INVENTION

Jounce bumpers are found in vehicle suspension systems and typically comprise an elastic body mounted coaxially around a shock absorber rod and fixed to a structural element of the vehicle, the jounce bumper providing an elastic cushion for the end of travel of the shock absorber and coil spring under compression. In some cases the elastic body does not encircle the shock absorber rod but is located beside it.

In a widely used arrangement, the jounce bumper is fixed to a structural element of the vehicle including a cushion cup, whereas the other end of the jounce bumper is configured to be struck by a striker plate or end wall of a shock absorber cylinder as it approaches its maximum compression travel. In some situations, initial contact between the jounce bumper and the shock absorber cylinder generates a noise that is undesired. Certain designs seek to reduce this contact noise, as described in JP 2006/038022 and KR 2008/067871. In JP 2006/038022, the jounce bumper is provided with a supple bending lip at an upper portion of the jounce bumper adjacent a structural component of the suspension system. This however has the drawback of making it difficult to properly fix the jounce bumper to the suspension system, or renders the attachment fragile and easily subject to rupture. In KR 2008/067871, it is proposed to provide fine protrusions covering a lower outer surface of the jounce bumper which does not comprise a specially formed bending lip for initial contact. In KR 2008/067871, the end of the jounce bumper that engages the striker plate of the shock absorber cylinder encircles the piston rod without any gap. This causes a less smooth deceleration than jounce bumpers provided with bending lips that coaxially surround the piston rod in a spaced manner and that provide a more progressive compression resistance. Also, in KR 2008/067871, after a certain amount of wear the jounce bumper may quickly loose its ability to reduce noise. It is also known to reduce noise of initial contact by providing a bending lip made of a material that generates less noise in view of its suppleness and damping characteristics, for example a bending lip made of polyurethane material as described in US2007/0017761. The drawback however is increased cost and/or reduced performance compared to integrally formed jounce bumpers comprising a bending lip and made of certain other materials, such as co-polyester elastomer jounce bumpers.

### SUMMARY OF THE INVENTION

It is an object of the invention to provide a jounce bumper that can be stably and robustly fixed to a vehicle suspension system and that generates a low noise on contact with the shock absorber cylinder.

It is advantageous to provide a jounce bumper that is made of materials well adapted to compressive shock loads in harsh environmental conditions over the expected life time of a vehicle.

It is advantageous to provide a jounce bumper that is economical to produce.

It is advantageous to provide a jounce bumper that is robust and reliable.

Disclosed herein is a jounce bumper for mounting in a vehicle suspension system comprising a shock absorber with a cylinder and a slidable piston rod, the jounce bumper including an elastically compressible bumper portion comprising an axially extending central bore for receiving the piston rod therethrough, if needed a mounting portion positioned at one end of the bumper portion configured for mounting the jounce bumper to a component of the vehicle suspension system, and a bending lip positioned at an opposite end of the bumper portion and configured to generally surround the piston rod, the bending lip comprising a contact edge configured to contact a striker plate or end wall of the shock absorber cylinder during compression of the shock absorber. The contact edge is configured to contact said striker plate or end wall on only part of a circumference surrounding the piston rod, at least during initial contact between the bending lip and striker plate or end wall.

Also disclosed herein is a jounce bumper comprising:
an elastically compressible bumper portion (24), said elastically compressible bumper portion comprising an axially extending central bore (15) for receiving a slidable piston rod therethrough;
a bending lip (30) on one end of said jounce bumper configured to generally surround said slidable piston rod, said bending lip comprising a contact edge, said contact edge configured to contact a striker plate (26) of a shock absorber during compression of said shock absorber,
wherein said contact edge is configured to contact said striker plate on only part of a closed circumference surrounding said slidable piston rod, at least during initial contact between said bending lip and striker plate; and
wherein the end of said jounce bumper opposite the bending lip is mounted to a component of a vehicle suspension system.

An additional object disclosed herein is a vehicle suspension component for mounting in a vehicle suspension system, said vehicle suspension component comprising:
a shock absorber with a cylinder (11), a slidable piston rod (12), and a jounce bumper (14), said jounce bumper comprising an elastically compressible bumper portion (24), said elastically compressible bumper portion comprising an axially extending central bore (15) for receiving said slidable piston rod therethrough;
a mounting portion (18) positioned at one end of said elastically compressible bumper portion and configured for mounting said vehicle suspension component to said vehicle suspension system;
a bending lip (30) positioned at an opposite end of said elastically compressible bumper portion and configured to generally surround said slidable piston rod, said bending lip comprising a contact edge configured to contact a striker plate of said shock absorber during compression of the shock absorber, wherein said contact edge is configured to contact said striker plate on only part of a closed circumference surrounding said slidable piston rod, at least during initial contact between said bending lip and striker plate.

The portion of said contact edge may advantageously be inclined with respect to a plane orthogonal to an axis of said central bore, in an uncompressed state.

The contact edge may advantageously be inclined with respect to said plane orthogonal to an axis of said central bore, in an uncompressed state.

An angle of inclination of said contact edge may advantageously be comprised in the range of 5° to 20°.

In an embodiment, the bending lip has a continuous contact edge configured to continuously surround the piston rod after initial contact between the bending lip and striker plate or end wall.

In another embodiment, the bending lip comprises a non-continuous contact edge configured to surround the piston rod in a non-continuous manner.

The bending lip may advantageously comprise a plurality of lobes separated by gaps arranged around the central bore.

The lobes may be arranged symmetrically around the central bore. The bending lip may comprise two lobes, three lobes, four lobes, or more.

The bending lip may advantageously be integrally formed with the elastically compressible bumper portion and of the same material as the elastically compressible bumper portion.

The bending lip may be integrally formed with the elastically compressible bumper portion in an injection molding process or an extrusion molding process.

The mounting portion may be integrally formed with the elastically compressible bumper portion and bending lip.

The jounce bumper may advantageously be made of a copolyester thermoplastic elastomer.

Further objects and advantageous aspects of the invention will be apparent from the claims, and from the following detailed description and accompanying figures.

### Definitions

As used herein, the term “shock absorber” refers to a mechanical device designed to absorb and dissipate energy and can be used to limit or dampen excessive suspension movement.

As used herein, the term “cylinder” refers to an internal component of a shock absorber which typically has a cylindrical or round shape of a specified diameter and within which a piston typically moves up and down.

As used herein, the term “slidable piston rod” refers to a rod which is attached to a piston and the piston resides within the cylinder of the shock absorber. The rod can move up or down depending on the movement of the automotive suspension system to which it is attached. The shock absorber can also move up or down while the rod is stationary with the effect on the piston being the same as when the rod is moved.

As used herein, the term “elastically compressible bumper portion” refers to a component of the jounce bumper which is capable of undergoing compression and then expansion back to the original shape before compression. The elastically compressible bumper portion can be any shape as long as it surrounds the slidable piston rod. The elastically compressible bumper portion is typically round or oval in shape when viewed from above or below along the length axis of the elastically compressible bumper portion.

As used herein, the term “axially extending central bore” refers to an open area created by the elastically compressible bumper portion and is capable of receiving the slidable piston rod.

As used herein, the term “mounting portion” refers to a component of the jounce bumper assembly which is used to attach the jounce bumper to the automotive suspension system. The mounting portion can be a metal plate or other design and configured for mounting and firmly attaching said jounce bumper to a component of the vehicle suspension system.

As used herein, the term “component of the vehicle suspension system” refers to a structural component of the vehicle suspension system to which the jounce bumper can be attached.

As used herein, the term “bending lip” refers to the part of the elastically compressible bumper portion positioned at one end of the jounce bumper and encircles or surrounds an opening or orifice.

As used herein, the term “contact edge” refers to the part of the bending lip which contacts a striker plate or end wall of a shock absorber during compression of the shock absorber.

As used herein, the term “striker plate” refers to a component of the shock absorber which is designed to contact the contact edge of the bending lip upon compression of the shock absorber.

### BRIEF DESCRIPTION OF THE DRAWINGS

FIG. 1a is a view in perspective of a jounce bumper according to an embodiment of the invention;

FIG. 1b is a view in cross-section of the jounce bumper of FIG. 1a;

FIG. 2a is a view in perspective of another embodiment of the jounce bumper according to the invention;

FIG. 2b is a cross-sectional view through the jounce bumper of FIG. 2a;

FIG. 3a is a view in perspective of a jounce bumper according to yet another embodiment of the invention;

FIG. 3b is a cross-sectional view through the jounce bumper of FIG. 3a;

FIG. 4a is a view in cross-section of a suspension system comprising a jounce bumper according to an embodiment of the invention, wherein the jounce bumper is in extension;

FIG. 4b is a view in cross-section of a suspension system comprising a jounce bumper of FIG. 4a, wherein the jounce bumper is in compression;

### DETAILED DESCRIPTION OF THE INVENTION

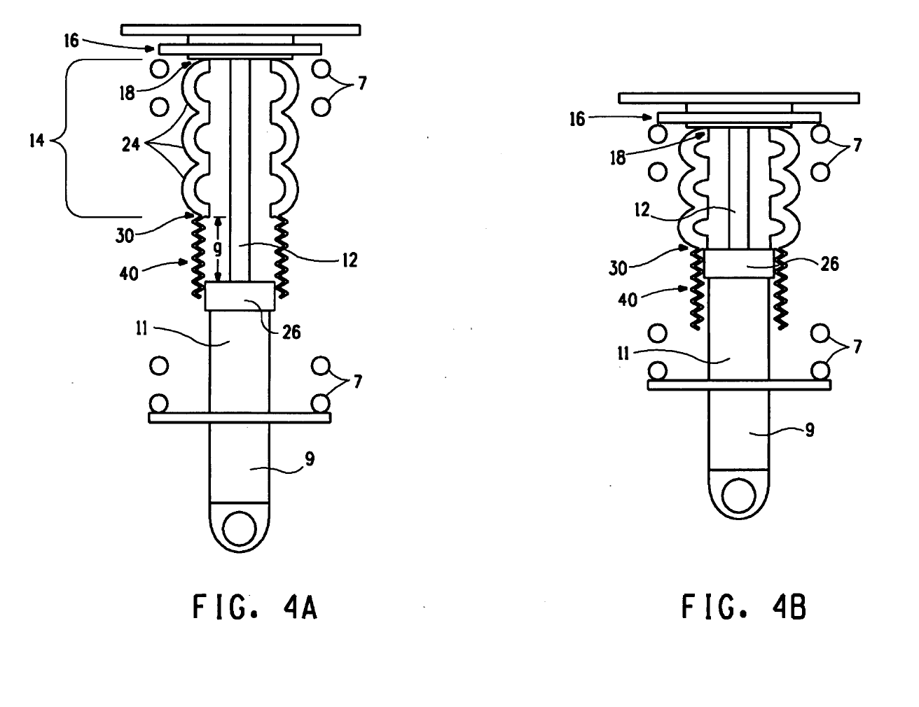

A vehicle suspension system illustrated in FIGS. 4a and 4b typically comprises a coil spring 7, a shock absorber 9, and a jounce bumper assembly 14. The coil spring 7 and shock absorber 9 are mounted between first and second vehicle structural elements that are relatively displaceable, the shock absorber 9 comprising a cylinder 11 and a movable piston rod 12. Referring to the figures, the jounce bumper assembly comprises a jounce bumper 14 and a cushion or saturation cup 16. The cushion cup 16 is part of, or fixed to, the vehicle structural element or elements to which the end of the shock absorber piston rod 12 is fixed. The cushion cup 16 serves to receive the jounce bumper 14 therein, as it is being compressed, and only when needed to limit the radial expansion of the jounce bumper 14 during compression thereof.

The jounce bumper 14 is fixed to the cushion cup 16 or to another structural element of the vehicle suspension system at the end of the shock absorber piston rod 12. Although the cushion cup is advantageous in many configurations, certain jounce bumpers may function without the cushion cup and may thus be fixed on a structural element that is not in the form of a cushion cup.

The jounce bumper 14 comprises an elastically compressible portion 24, a mounting portion 18 for fixing the jounce bumper to a structural element of the suspension system, and a central bore 15 extending through the compressible portion and the mounting portion for enabling the mounting of the jounce bumper around the shock absorber piston rod 12. Optionally, the jounce bumper may comprise an integrated dust cover 40.

The mounting portion 18 is advantageously integrally formed with the elastically compressible portion 24. In an advantageous embodiment, the mounting portion is formed with the compressible portion as a single injection molded piece in the same material. It is also possible to have a mounting portion that is formed of, or comprising, a different material to the elastically compressible portion, for example in a multi-component molding process. The jounce bumper may advantageously be made by an injection blow molded process, for instance as described in US Patent Application Publication 2008/0272529.

The jounce bumper according to preferred embodiments of this invention may advantageously be made of a copolyester thermoplastic elastomer as a single part by injection blow molding, providing a robust and resistant jounce bumper with high performance compression characteristics that is nevertheless economical to produce and to assemble.

A free end of the elastically compressible bumper portion 24 of the jounce bumper 14, opposite the mounting portion 18, comprises a bending lip 30 configured to strike an end wall or striker plate 26 of the shock absorber cylinder, an inner contact edge 32 of the bending lip preferably configured to be separated from the piston rod 12 by a gap or spacing g. During contact, the bending lip pivots inwardly such that the gap g is reduced until the bending lip presses against the remainder of the elastically compressible bumper portion 24, the compression of the bending lip and subsequent convolutions of the compressible portion 24 generating a progressive compression resistance against the end of travel compression of the suspension system. Optionally, the jounce bumper may also comprise an integrated dust cover 40 configured to cover the piston rod 12. Usually the integrated dust cover 40 is affixed at the opposite end of the mounting portion 18.

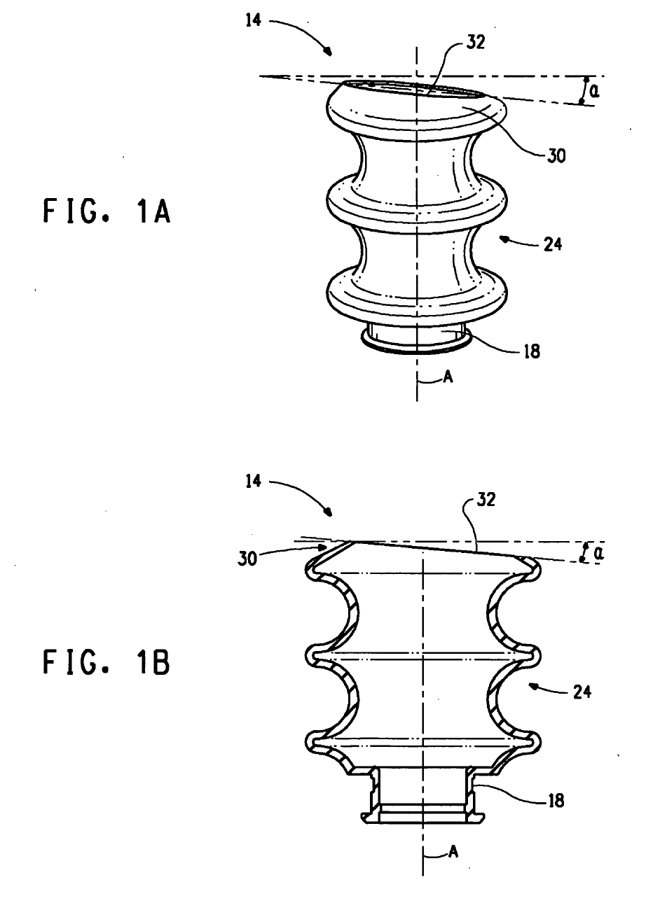

In a first embodiment illustrated in FIGS. 1a and 1b, the bending lip 30 is inclined with respect to a central axis A of the central bore 15 of the jounce bumper, corresponding to the axis of the piston rod 12, such that initial contact between the bending lip 30 and the end wall or striker plate of the shock absorber initially occurs along a portion of the circumference of the bending lip, for instance a portion of the bending lip that represents less than 50% of the circumference of the bending lip surrounding the piston rod. In the embodiment illustrated in FIGS. 1a and 1b, the bending lip is inclined at a constant continuous angle a that may advantageously be comprised in the range of 5° to 20°, preferably in the range or 5° to 15°, with respect to a plane orthogonal to the central axis A. Variants of the exemplary embodiment may also be provided without departing from the scope of the invention, for instance the inclination of the bending surface may be non-linear, for example curved, convexly. or concavely, or there may be more than two angles of inclination, or a portion of the bending lip that initially contacts may be essentially orthogonal to the central axis A over a circumference representing 50% or less around the central bore, the remainder of the bending lip being inclined with respect to the plane orthogonal to the central axis.

For these variants, it shall be considered herein that the bending lip has an average or a general inclination a with respect to the plane orthogonal to the axis A that is advantageously in the range of 5° to 20°, preferably in the range of 5° to 15°.

The inclined or generally inclined bending lip advantageously provides a contact surface that progressively increases around the circumference of the jounce bumper during the initial stage of compression of the jounce bumper and that reduces the acoustic pressure during initial contact.

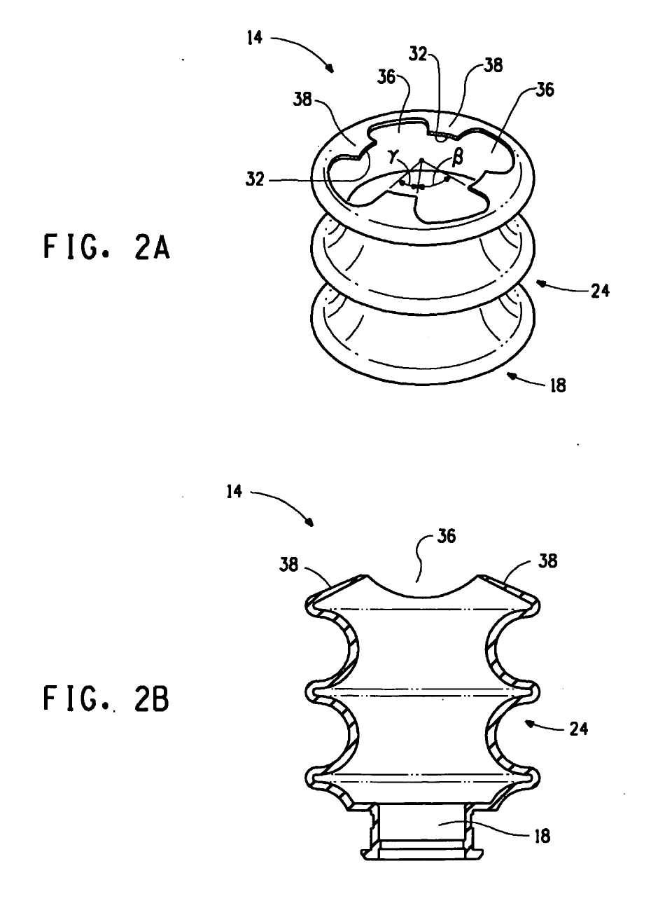

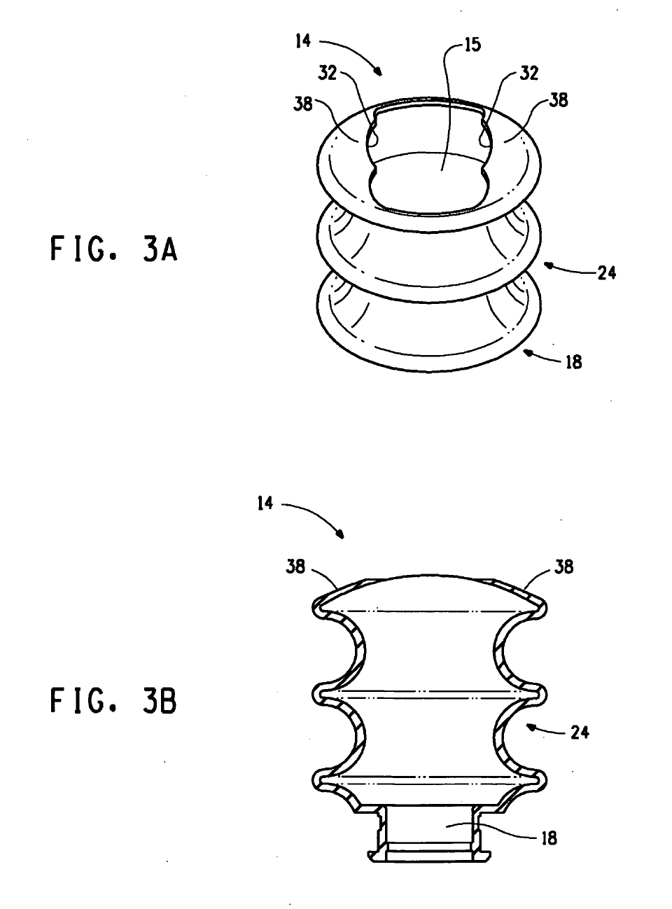

Referring to FIGS. 2a, 2b and 3a, 3b variants of another embodiment of a jounce bumper according to the invention is illustrated. In this embodiment, the bending lip 30 is non-continuous, or at least comprises a non-continuous inner contact edge 32, in that the inner contact edge 32 comprises a plurality of initial contact portions 38 interrupted by voids 36 arranged around the central bore, such that the bending lip contacts the end wall or striker plate 26 of the shock absorber along a portion of the circumference of the jounce bumper surrounding the central bore during initial contact. As illustrated, the bending lip may advantageously be in the form of two, three, four, or more lobes, preferably symmetrically arranged around the central bore and separated by voids. The interruptions or voids may have a circumferential angle β that may be equal to or within the range of 0.8 to 1.2 times the angle γ of a lobe 38. The edge 32 of the voids 36 may advantageously have a curved form, so that the base of the lobe 38 connecting the bending lip to the compressible bumper portion 24 has a gradually increasing width.

The initial contact between the bending lip and the shock absorber thus occurs over a portion of the circumference of the jounce bumper that may for instance be in the range of 40% to 70% of the total circumference, configured to reduce the initial acoustic pressure, inter alia by the ability for the air in the contact zone to escape laterally to the voids.

1. Jounce bumper (14) for mounting in a vehicle suspension system, said vehicle suspension system comprising a shock absorber with a cylinder and a slidable piston rod (12), said jounce bumper (14) including an elastically compressible bumper portion (24), said elastically compressible bumper portion comprising an axially extending central bore (15) for receiving said slidable piston rod therethrough; a mounting portion (18) positioned at one end of said elastically compressible bumper portion, said mounting portion configured for mounting said jounce bumper to a component of said vehicle suspension system, and a bending lip (30) positioned at an opposite end of said elastically compressible bumper portion and configured to generally surround said slidable piston rod, said bending lip comprising a contact edge configured to contact a striker plate (26) of said shock absorber during compression of the shock absorber, wherein said contact edge is configured to contact said striker plate on only part of a closed circumference surrounding said slidable piston rod, at least during initial contact between said bending lip and striker plate.

2. Jounce bumper according to claim 1, wherein at least a portion of said contact edge is inclined at an angle of inclination of from about 5 degrees to about 20 degrees with respect to a plane orthogonal to an axis of said central bore, in an uncompressed state.

3. Jounce bumper according to claim 1, wherein said bending lip has a continuous contact edge configured to continuously surround said slidable piston rod after initial contact between said bending lip and striker plate.

4. Jounce bumper according to claim 1, wherein said bending lip comprises a non-continuous contact edge configured to surround said slidable piston rod.

5. Jounce bumper according to claim 1, wherein said bending lip comprises a plurality of lobes separated by gaps arranged around said axially extending central bore.

6. Jounce bumper according to claim 5, wherein said bending lip comprises at least two lobes.

7. Jounce bumper according to claim 1, wherein said bending lip is integrally formed with said elastically compressible bumper portion.

8. Jounce bumper according to claim 1, wherein said bending lip is formed of the same material as said elastically compressible bumper portion.

9. Jounce bumper according to claim 1, wherein said bending lip is integrally formed with said elastically compressible bumper portion in a molding process.

10. Jounce bumper according to claim 1, wherein said mounting portion is integrally formed with said elastically compressible bumper portion and bending lip.

11. Jounce bumper according to claim 1, wherein said jounce bumper is made of a copolyester thermoplastic elastomer.

12. A vehicle suspension component for mounting in a vehicle suspension system, said vehicle suspension component comprising:
a shock absorber with a cylinder (11), a slidable piston rod (12); and a jounce bumper (14), said jounce bumper comprising an elastically compressible bumper portion (24), said elastically compressible bumper portion comprising an axially extending central bore (15) for receiving said slidable piston rod therethrough;
a mounting portion (18) positioned at one end of said elastically compressible bumper portion and configured for mounting said vehicle suspension component to said vehicle suspension system;
a bending lip (30) positioned at an opposite end of said elastically compressible bumper portion and configured to generally surround said slidable piston rod, said bending lip comprising a contact edge configured to contact a striker plate of said shock absorber during compression of the shock absorber, wherein said contact edge is configured to contact said striker plate on only part of a closed circumference surrounding said slidable piston rod, at least during initial contact between said bending lip and striker plate.

13. A jounce bumper comprising:
an elastically compressible bumper portion (24), said elastically compressible bumper portion comprising an axially extending central bore (15) for receiving a slidable piston rod therethrough;
a bending lip (30) on one end of said jounce bumper configured to generally surround said slidable piston rod, said bending lip comprising a contact edge, said contact edge configured to contact a striker plate (26) of a shock absorber during compression of said shock absorber,
wherein said contact edge is configured to contact said striker plate on only part of a closed circumference surrounding said slidable piston rod, at least during initial contact between said bending lip and striker plate; and
wherein the end of said jounce bumper opposite the bending lip is mounted to a component of a vehicle suspension system.

14. Jounce bumper according to claim 13, wherein at least a portion of said contact edge is inclined at an angle of inclination of from about 5 degrees to about 20 degrees with respect to a plane orthogonal to an axis of said central bore, in an uncompressed state.

15. Jounce bumper according to claim 13, wherein said bending lip is integrally formed with said elastically compressible bumper portion.

16. Jounce bumper according to claim 13, wherein said bending lip is formed of the same material as said elastically compressible bumper portion.

17. Jounce bumper according to claim 13, wherein said bending lip is integrally formed with said elastically compressible bumper portion in a molding process.

18. Jounce bumper according to claim 13, wherein said mounting portion is integrally formed with said elastically compressible bumper portion and bending lip.

19. Jounce bumper according to claim 13, wherein said jounce bumper is made of a copolyester thermoplastic elastomer.

20. Jounce bumper according to claim 13, wherein said bending lip comprises a plurality of lobes separated by gaps arranged around said axially extending central bore.
